(19) United States
(12) Patent Application Publication
(10) Pub. No.: US 2015/0041073 A1
(43) Pub. Date: Feb. 12, 2015

(54) CONTROL UNIT FOR WINDOW CURTAIN ASSEMBLY

(71) Applicant: CHING FENG HOME FASHIONS CO., LTD., Fuxing Shiang (TW)

(72) Inventors: SHENG-YING HSU, Fuxing Shiang (TW); CHUN JAN HSU, Fuxing Shiang (TW)

(73) Assignee: CHING FENG HOME FASHIONS CO., LTD., Fuxing Shiang (TW)

(21) Appl. No.: 14/077,199

(22) Filed: Nov. 11, 2013

(30) Foreign Application Priority Data
Aug. 9, 2013 (TW) 102214958

(51) Int. Cl. E06B 9/322; E06B 9/34; E06B 9/327

(52) U.S. Cl. CPC E06B 9/322; E06B 9/327; E06B 9/34; E06B 2009/3222
USPC 160/192

(57) ABSTRACT

A control unit and a fixed part of a window curtain assembly are positioned in the head box. A movable part is movably located between the control unit and the fixed part. The control unit has a base part, an assistance part and a resilient member. The base part is secured in the head box and a first end of a transmission cord is fixed to the base part, and a second end of the transmission cord goes around the assistance part and the fixed part, and then is fixed to the movable part. The spring is connected between the assistance part and the movable part. When moving the bottom bar downward, the movable part is moved by the connection cord connected to the bottom bar and the transmission cord is moved to release the connection cord.

### FIELD OF THE INVENTION

The present invention relates to a window curtain assembly, and more particularly, to a control unit for a window curtain assembly, wherein no operation cords are needed.

### BACKGROUND OF THE INVENTION

The conventional window curtain assembly is installed to the interior of a room and includes a shade or blinds to adjust the light from outside of the room. The latest window curtain assemblies are developed to be cordless which means no operation cords are exposed on two sides of the curtain. The conventional cordless window curtain assembly generally comprises a head box with a control unit located therein and the transmission cord is connected to the control unit and is cooperated with a movable part which is connected with a connection cord that extends through the slats and is connected to the bottom bar of the curtain assembly. There is no operation cords needed, so that the user simply moves the bottom bar to adjust the height of the blinds.

Taiwan Utility Model No. M296300 discloses a cordless window curtain assembly wherein the rotatable part of the control unit has a shaft which is located between two torsion springs. The torsion spring lift or lower the blinds according to the operation of the transmission cord and the rotation of the rotatable part. When the user pulls the bottom bar downward, the connection cords release the blinds. The movable part is rotated to release the connection cords and moves toward the fixed part in the head box. The movement of the movable part drives the rotatable part which releases the transmission cord. The two torsion springs are collected in parallel so as to provide sufficient force to retract.

The length of the travel of the movable part is longer along with the longer distance that the blinds need to move. However, the control unit is not movable, the movable part is moved by the force of the torsion springs which tend to be fatigue after frequent uses. When the torsion springs cannot provide sufficient force, the blinds cannot be lowered to the desired position.

The present invention intends to provide a control unit for a window curtain assembly to improve the shortcomings mentioned above.

### SUMMARY OF THE INVENTION

The present invention relates to a control unit for a window curtain assembly and comprises a head box, a bottom bar and multiple slats connected between the head box and the bottom bar. The control unit is positioned in the first end of the head box, and a fixed part is positioned in the second end in the head box. The control unit has a base part, an assistance part and a resilient member. The fixed part is fixed to the first end of the head box and has a horizontal first passage. The assistance part has a horizontal second passage. The assistance part has a first fixing member extending through the second passage and secures the assistance part to the head box.

A resilient member has a first end and a second end, wherein the first end is connected to the first fixing member of the assistance part. A movable part is movably located between the control unit and the fixed part. The movable part has a second fixing member to which the second end of the resilient member is connected. A transmission cord has a first end fixed to the base part, and a second end of the transmission cord goes around a portion of the assistance part and around a portion of the base part, and then extends parallel to the resilient member. The second end of the transmission cord goes around a portion of the fixed part and then is fixed to a portion of the movable part. A connection cord has a first end fixed to a bottom bar and a second end of the connection cord extends through slats of the window curtain assembly and then movably goes through the movable part and the fixed part. The second end the connection cord then extends through the slats of the window curtain assembly and is connected to the bottom bar.

When moving the bottom bar downward, the movable part is moved by the connection cord and the transmission cord is moved to release the connection cord, so that the curtain assembly is lowered by operation to the bottom bar.

Preferably, the base part has a top end and a bottom end. The first passage is defined horizontally between the top and bottom ends of the base part. A first pillar is located in the first passage and connected between the top and bottom ends of the base part. A securing pillar is located beside the first pillar and the first end of the transmission cord is fixed to the securing pillar. A second pillar is located in the second passage of the assistance part and the second end of the transmission cord goes around the second pillar and then goes around back to the first pillar. The second end of the transmission cord then extends parallel to the resilient member and goes around the portion of the fixed part and then is fixed to the portion of the movable part.

Preferably, the movable part has a third passage and the second fixing member extends into the third passage. A second end of the resilient member is connected to the second fixing member. A third pillar is located in the third passage and located beside the second fixing member. The second end of the transmission cord is fixed to the third pillar of the movable part.

Preferably, the fixed part has a fourth passage defined therein and a positioning pillar is located in the center of the fourth passage. A fourth pillar is located beside the positioning pillar. The second end of the transmission cord goes around the fourth pillar and then is fixed to the movable part.

Preferably, two first rods are located on two sides of the third pillar of the movable part. Two second rods are located on two sides of the positioning pillar of the fixed part and located corresponding to the first rods. The second end of the connection cord extends through a first hole of the head box and goes around one of the second rods of the fixed part, one of the first rods of the movable part, the other one of the second rods of the fixed part and the other one of the first rods of the movable part. The second end of the connection cord 60 then goes around the positioning pillar and extends through a second hole of the head box. The second end of the connection cord extends through the slats and is connected to the bottom bar.

The present invention is a cordless window curtain assembly, the resilient member of the control unit is cooperated with an assistance part so that when the movable part moves, the transmission cord is moved and the assistance part is also moved. The assistance part and the movable part is connected to the resilient member so that the movement of the assistance part and the resilient member increase the travel distance of the movable part such that the connection cord is released for a longer length. By this specific arrangement, the travel distance of the curtain is increased.

Because the assistance part is movable so that the resilient member does not need to be extended too long, by this way, the resilient member has longer life.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the control unit of the window curtain assembly of the present invention;

FIG. 2 is a top view of the control unit of the window curtain assembly of the present invention;

FIG. 3 is a side cross sectional view of the control unit of the window curtain assembly of the present invention;

FIG. 4 is a top view to show the first action of the control unit of the window curtain assembly of the present invention;

FIG. 5 is a top view to show the second action of the control unit of the window curtain assembly of the present invention, and

FIG. 6 is a side view to show that the control unit of the window curtain assembly of the present invention is activated.

### DETAILED DESCRIPTION OF THE PREFERRED EMBODIMENT

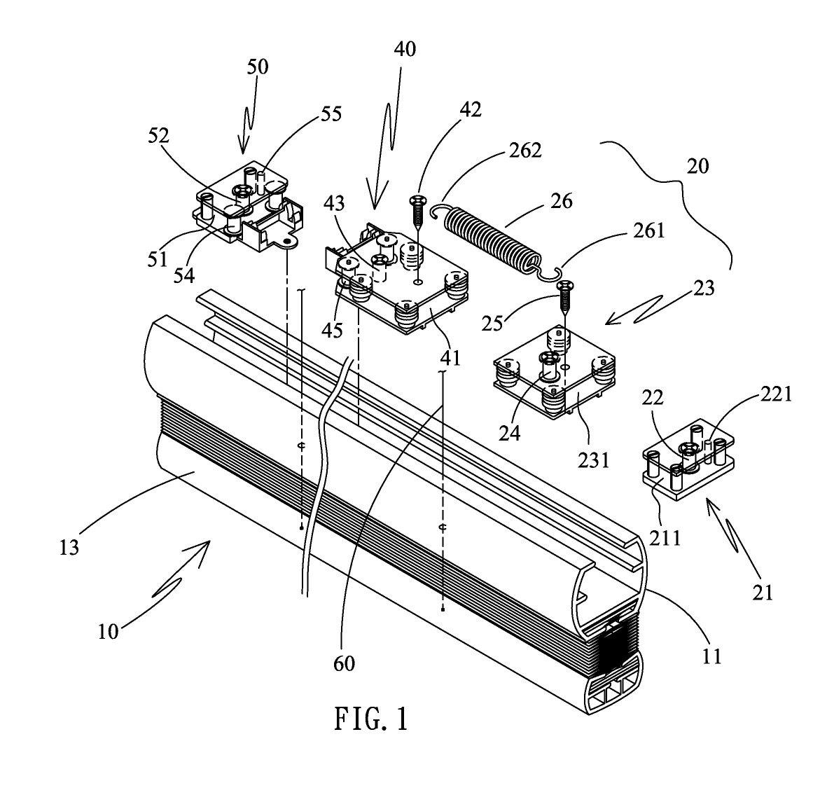

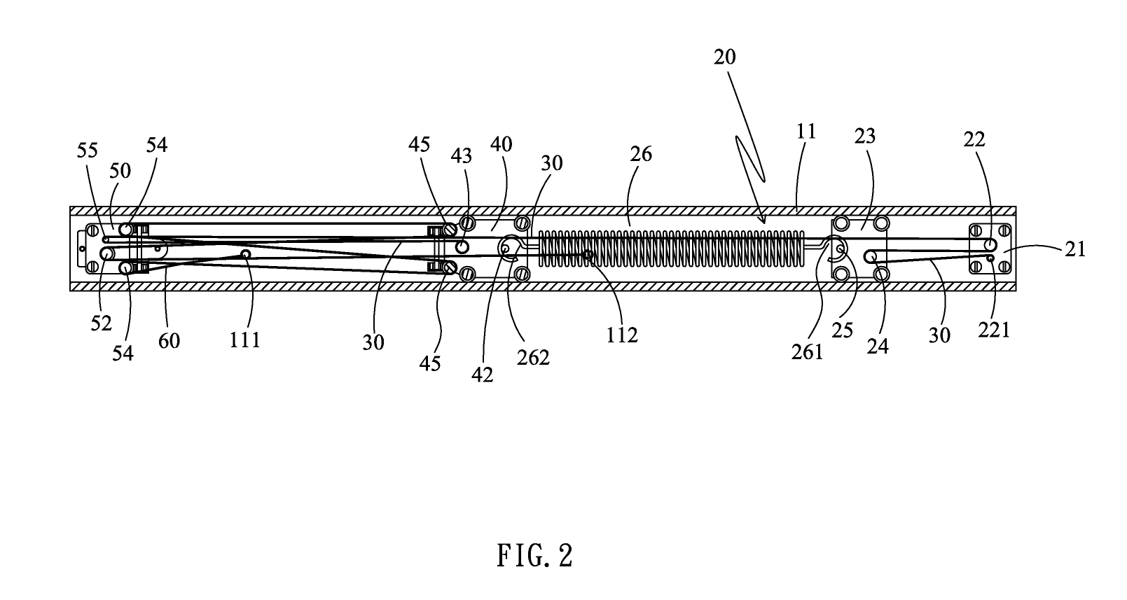

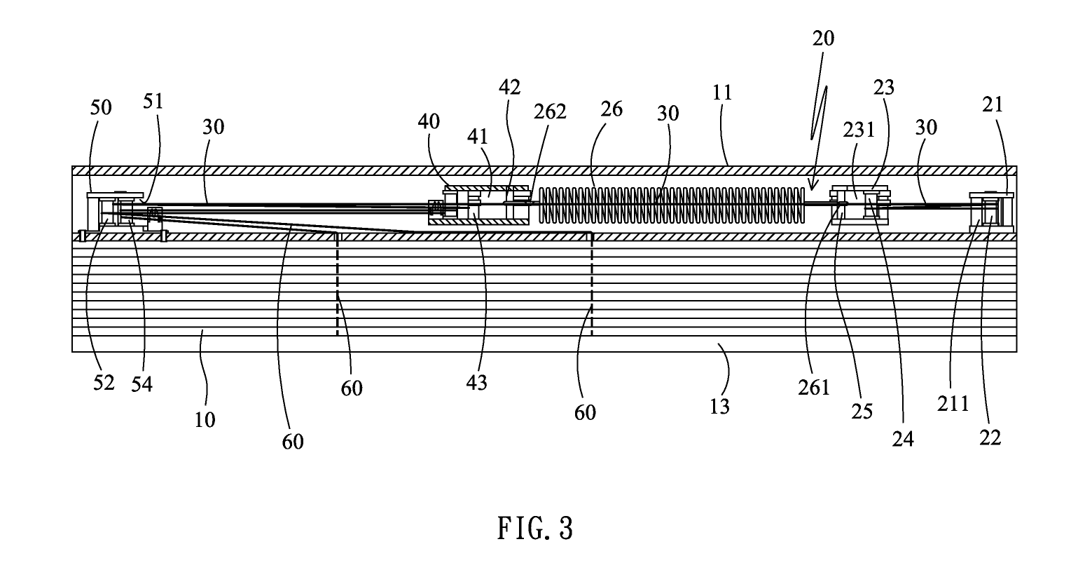

Referring to FIGS. 1 and 2, the window curtain assembly 10 of the present invention comprises a head box 11, a bottom bar 12 and multiple slats connected between the head box 11 and the bottom bar 12. The head box 11 has a U-shaped space and a control unit 20 is positioned in the first end of the head box 11. A fixed part 50 is positioned in the second end in the head box 11. A movable part 40 is movably connected between the fixed part 50 and the control unit 20. A transmission cord 30 is connected to the control unit 20, the fixed part 50 and the movable part 40. A connection cord 60 extends through the slats 60 and is connected to the movable part 40 and the fixed part 50.

The control unit 20 has a base part 21, an assistance part 23 and a resilient member 26, wherein the fixed part 21 is fixed to the first end of the head box 11 and has a top end and a bottom end. A first passage 211 is defined horizontally between the top and bottom ends of the base part 21. A first pillar 22 is located in the first passage 211 and connected between the top and bottom ends of the base part 21. A securing pillar 221 is located beside the first pillar 22.

The assistance part 23 has a horizontal second passage 231. A second pillar 24 is located in the second passage 231 of the assistance part 23. A first fixing member 25 extends through the second passage 231.

The resilient member 26 is a linear spring and has a first end 261 and a second end 262. The first end 261 is inserted into the second passage 231 and connected to the first fixing member 25 of the assistance part 23, so that the resilient member 26 is connected with the assistance part 23.

The movable part 40 has a third passage 41 and the second fixing member 42 extends into the third passage 41. The second end 262 of the resilient member 26 is connected to the second fixing member 42. A third pillar 43 is located in the third passage 41 and located beside the second fixing member 42. Two first rods 45 are located on two sides of the third pillar 43 of the movable part 40.

The fixed part 50 has a fourth passage 51 defined therein and a positioning pillar 52 is located in a center of the fourth passage 51. A fourth pillar 55 is located beside the positioning pillar 52. In addition, two second rods 54 are located on two sides of the positioning pillar 52 of the fixed part 50 and located corresponding to the first rods 45.

The transmission cord 30 has the first end thereof fixed to the securing pillar 221, and the second end of the transmission cord 30 goes around the second pillar 24 and then goes around back to the first pillar 22. The second end of the transmission cord 30 then extends parallel to the resilient member 26 and goes around the fourth pillar 55 and then is fixed to the third pillar 43 of the movable part 40.

The connection cord 60 has the first end fixed to a bottom bar 13. The second end of the connection cord 60 extends through the slats of the window curtain assembly 10 and extends through a first hole 111 of the head box 11 and goes around one of the second rods 54 of the fixed part 50, one of the first rods 45 of the movable part 40, the other one of the second rods 54 of the fixed part 50 and then the other one of the first rods 45 of the movable part 40. The second end of the connection cord 60 then goes around the positioning pillar 52 and extends through a second hole 112 of the head box 11. The second end of the connection cord 60 then extends through the slats and is connected to the bottom bar 13. In other words, the two ends of the connection cord 60 are both connected to the bottom bar 13.

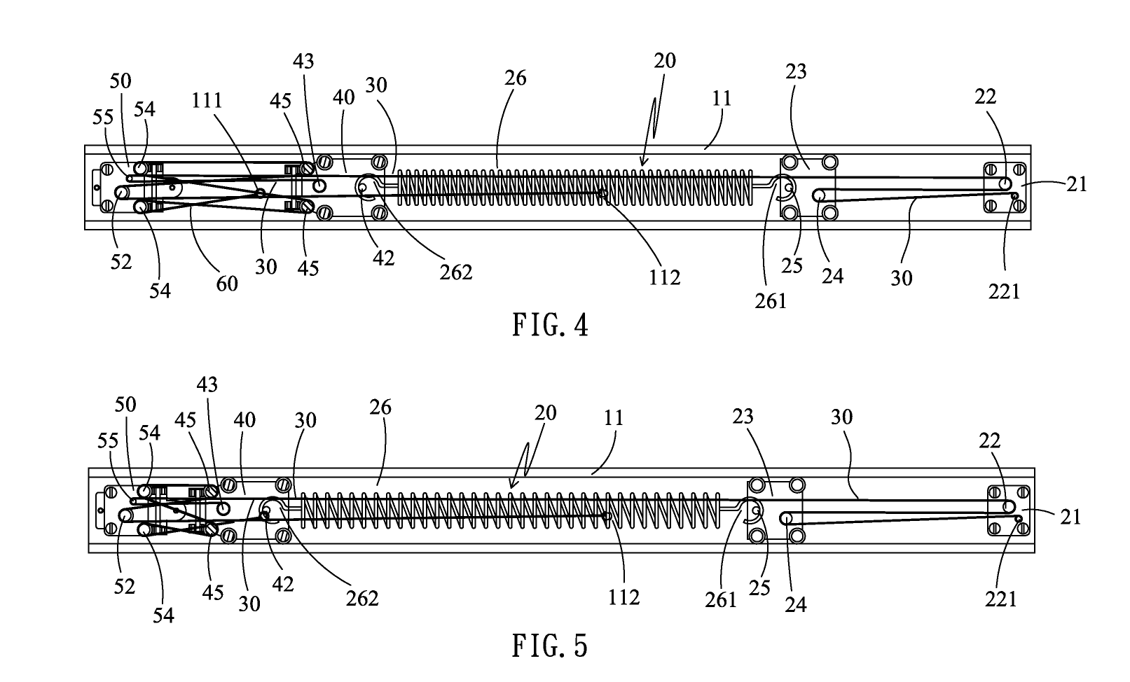

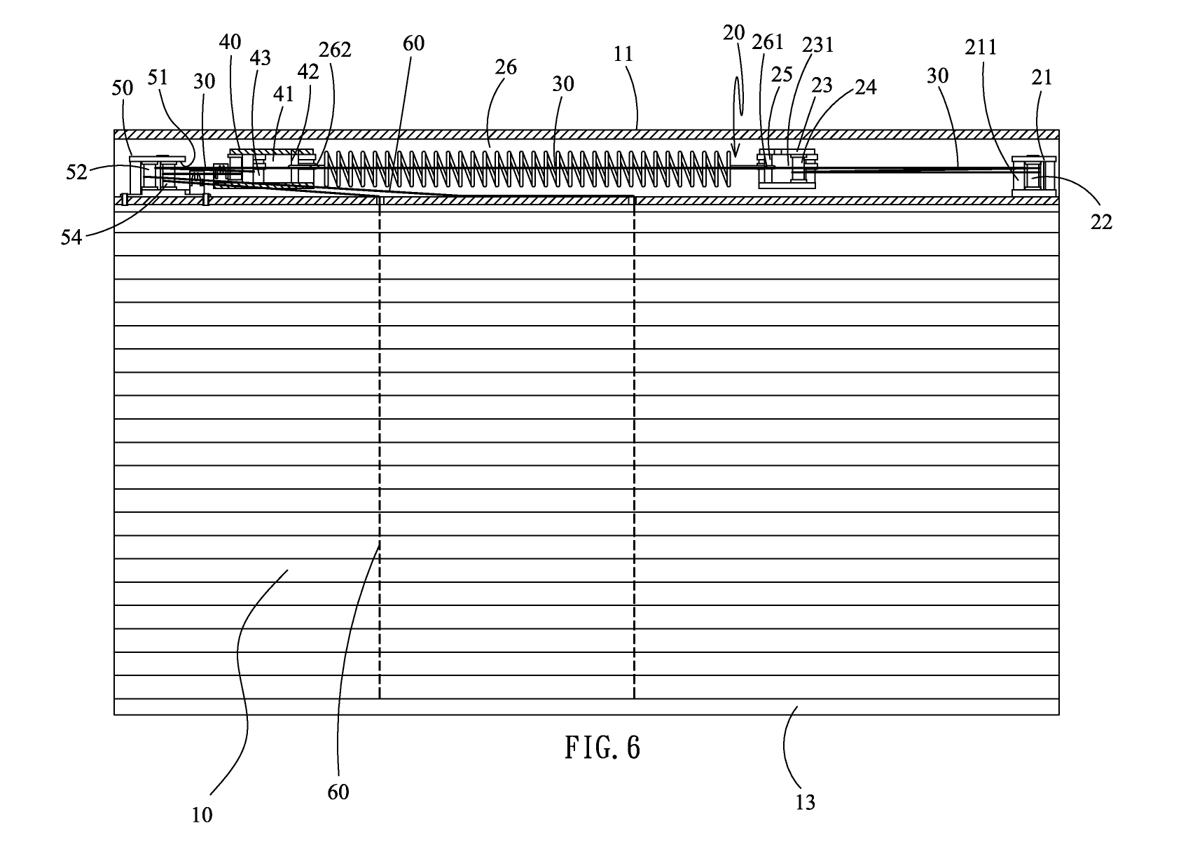

As shown in FIGS. 4 to 6, when the user pulls the bottom bar 13, the connection cord 60 moves relative to the second rod 54 in the fixed part 50 and moves the movable part 40 which stretches the resilient member 26 of the control unit 20 such that the moveable part 40 moves a longer distance to allow the connection cord 60 to lower the slats to a even longer distance. When the resilient member 26 is stretched by the movement of the movable part 40, the assistance part 23 is moved along with the movement of the transmission cord 30 which is moved by the resilient member 26. The travel distance of the assistance part 23 causes that the resilient member 26 does not need to be stretched more distance. In other words, the travel distance of the assistance part 23 and the stretch distance of the resilient member 26 allow the movable part 40 to move more close to the fixed part 50. This allows the connection cord 60 to be released more distance to let the curtain to cover longer windows in vertical direction. Besides, the resilient member 26 can avoid fatigue and has longer life of use.

When the bottom bar 13 is released, the resilient member 26 bounces back and the assistance part 23 moves back to its original position. The force of the resilient member 26 pulls the movable part 40 which retracts the connection cord 60 so that the curtain is positioned at the current height. The current can be lifted by further pushing the bottom bar 13 upward.

While we have shown and described the embodiment in accordance with the present invention, it should be clear to those skilled in the art that further embodiments may be made without departing from the scope of the present invention.

What is claimed is:

1. A control unit for a window curtain assembly, comprising:
a head box and a control unit positioned in a first end of the head box, a fixed part positioned in a second end in the head box, the control unit having a base part, an assistance part and a resilient member, the fixed part fixed to the first end of the head box and having a horizontal first passage, the assistance part having a horizontal second passage, the assistance part having a first fixing member extending through the second passage;
a resilient member having a first end and a second end, the first end connected to the first fixing member of the assistance part;
a movable part movably located between the control unit and the fixed part, the movable part having a second fixing member to which the second end of the resilient member is connected, and
a transmission cord having a first end fixed to the base part, a second end of the transmission cord going around a portion of the assistance part and going around a portion of the base part and extending parallel to the resilient member, the second end of the transmission cord going around a portion of the fixed part and then fixed to a portion of the movable part, and
a connection cord having a first end fixed to a bottom bar and a second end of the connection cord extending through slats of the window curtain assembly and then movably going through the movable part and the fixed part, the second end the connection cord then extending through the slats of the window curtain assembly and connected to the bottom bar, when moving the bottom bar downward, the movable part is moved by the connection cord and the transmission cord is moved to release the connection cord.

2. The control unit as claimed in claim 1, wherein the base part has a top end and a bottom end, the first passage is defined horizontally between the top and bottom ends of the base part, a first pillar is located in the first passage and connected between the top and bottom ends of the base part, a securing pillar is located beside the first pillar and the first end of the transmission cord is fixed to the securing pillar, a second pillar is located in the second passage of the assistance part, the second end of the transmission cord goes around the second pillar and then goes around the first pillar, the second end of the transmission cord then extends parallel to the resilient member and goes around the portion of the fixed part and then is fixed to the portion of the movable part.

3. The control unit as claimed in claim 1, wherein the movable part has a third passage and the second fixing member extends into the third passage, a second end of the resilient member is connected to the second fixing member, a third pillar is located in the third passage and located beside the second fixing member, the second end of the transmission cord is fixed to the third pillar of the movable part.

4. The control unit as claimed in claim 1, wherein the fixed part has a fourth passage defined therein and a positioning pillar is located in a center of the fourth passage, a fourth pillar is located beside the positioning pillar, the second end of the transmission cord goes around the fourth pillar and then is fixed to the movable part.

5. The control unit as claimed in claim 4, wherein two first rods are located on two sides of the third pillar of the movable part, two second rods are located on two sides of the positioning pillar of the fixed part and located corresponding to the first rods, the second end of the connection cord extends through a first hole of the head box and goes around one of the second rods of the fixed part, one of the first rods of the movable part, the other one of the second rods of the fixed part and then the other one of the first rods of the movable part, the second end of the connection cord then goes around the positioning pillar and extends through a second hole of the head box, the second end of the connection cord extends through the slats and is connected to the bottom bar.
